(19) United States
(12) Patent Application Publication
(10) Pub. No.: US 2010/0045241 A1
(43) Pub. Date: Feb. 25, 2010

(54) Piezoelectric Kinetic Energy Harvester

(75) Inventor: Jari Olavi Nousiainen, Espoo (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/194,711

(22) Filed: Aug. 20, 2008

(51) Int. Cl. H02J 7/00

(52) U.S. Cl. 320/137

(57) ABSTRACT

A battery for an electronic device is contained within a first frame that is coupled to a second frame by one or more piezoelectric elements. The second frame is coupled to a device chassis by one or more additional piezoelectric elements. In response to translation and/or rotation of the electronic device, portions of forces induced by the battery mass are transferred to the piezoelectric elements. Electrical energy output by these piezoelectric elements is received in a power controller and can be applied to the battery. Additional device components can also be contained within the first frame so as to increase the total mass that induces forces applied to the piezoelectric elements.

### BACKGROUND

Battery-powered electronic devices have become an ubiquitous part of modern life. Such devices include, but are not limited to, cellular telephones, “smart” phones and other wireless communication devices, personal digital assistants, laptop computers, broadcast receivers, portable music players, etc. The conveniences offered by these devices continue to increase as more features are developed and greater services become available. This increased convenience comes at a cost, however, as additional features and services often require additional battery power. Extending battery longevity, which has long been a challenge, becomes increasingly difficult as more and more power is needed.

Kinetic energy harvesting has the potential to at least partially address this challenge. Battery powered devices are often portable. Indeed, many such devices easily fit within a pocket or purse and experience continued motion over relatively long periods of time. Associated with that motion is acceleration in numerous directions, which acceleration causes masses of various elements within the device to impose a variety of forces. If a significant portion of the energy associated with those forces can be converted to electrical energy, such electrical energy could be used to at least partially recharge the device battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a device according to at least some embodiments, kinetic energy resulting from acceleration of a battery powered device is harvested using piezoelectric elements that are positioned to receive forces along multiple different axes. So as to increase the amount of forces on those piezoelectric elements, the mass inducing such forces is increased by locating heavier device components within an assembly that transfers forces to the piezoelectric elements in response to device translation and/or rotation. In some embodiments, the device battery can be contained within that assembly. In still other embodiments, a display, a transceiver, a keypad and/or other device components are contained within that force-transferring assembly. In response to translation and/or rotation of the device, portions of forces induced by the battery mass and/or other device components are transferred to the piezoelectric elements. Electrical energy output by these piezoelectric elements is received in a power controller and can be applied to the battery.

### BRIEF DESCRIPTION OF THE DRAWINGS

Some embodiments of the present invention are illustrated by way of example, and not by way of limitation, in the figures of the accompanying drawings and in which like reference numerals refer to similar elements.

FIG. 1 is a block diagram of an exemplary electronic device in which at least some embodiments may be implemented.

FIG. 2 is a partially schematic top view of a kinetic energy harvester (“KE harvester”) according to at least some embodiments.

FIGS. 3A-3E are side (and in some cases, cross-sectional) views of the KE harvester of FIG. 2 taken from the locations shown in FIG. 2.

FIGS. 4 and 5 are top and side views, respectively, of the KE harvester of FIG. 2 illustrating forces imposed on piezoelectric elements in response to device translation.

FIGS. 6 and 7 are top and side views of the KE harvester of FIG. 2 illustrating forces imposed on piezoelectric elements in response to device rotation.

FIG. 8 is top view of a KE harvester according to another embodiment.

FIG. 9 is a perspective view of a KE harvester according to yet another embodiment.

FIG. 10 is an exploded perspective view of a mobile terminal having a KE harvester according to a further embodiment.

FIG. 11 is a flow chart showing generation of energy using a KE harvester according to one or more of the herein-described embodiments.

### DETAILED DESCRIPTION

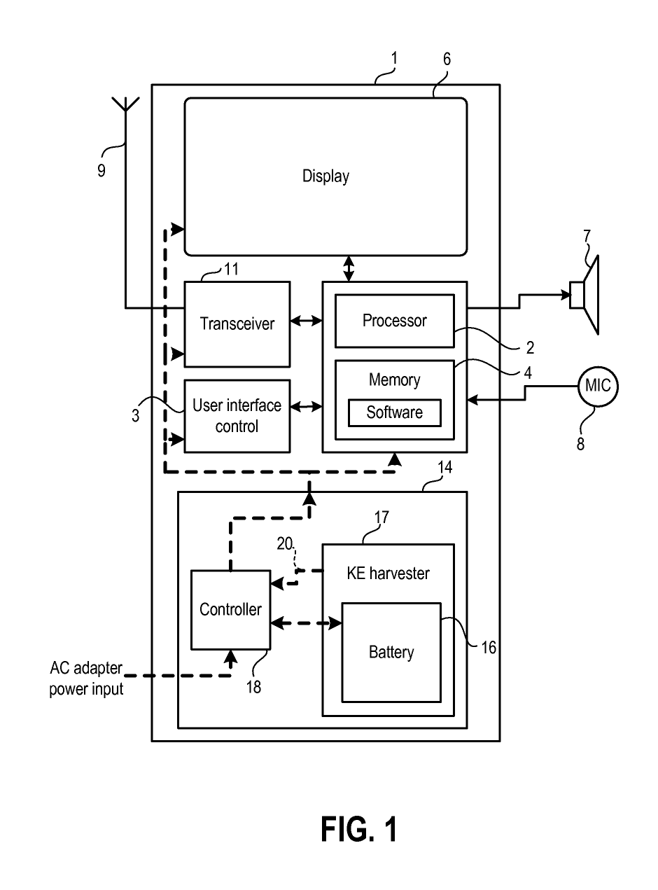

FIG. 1 is a block diagram of a mobile terminal 1, an exemplary electronic device in which at least some embodiments of the invention may be implemented. Mobile terminal 1 includes one or more processors 2. Said processors are communicatively connected to user interface control 3, memory 4 and/or other storage, and a display 6. Mobile terminal 1 may further include a speaker 7, microphone 8 and antenna 9. User interface control 3 may include controllers or adapters configured to receive input from or provide output to a keypad, touch screen, voice interface (microphone), function keys, joystick, data glove, mouse and the like. Instructions readable and executable by processor 2, as well as data and other elements may be stored in a storage facility such as memory 4. Memory 4 may be implemented with any combination of read only memory (ROM) modules or random access memory (RAM) modules, optionally including both volatile and nonvolatile memory. Software may be stored within memory 4 to provide instructions to processor 2 such that when the instructions are executed, processor 2 and/or other elements of mobile terminal 1 are caused to perform various operations associated with mobile terminal 1. Software may include both applications and operating system software, and may include code segments, instructions, applets, pre-compiled code, compiled code, computer programs, program modules, engines and program logic. Additionally, mobile terminal 1 is configured to receive and/or transmit, decode and/or code and otherwise process various types of wireless communications using one or more transceivers 11.

The electronic components of mobile terminal 1 receive power from a power unit 14. For convenience, bold broken-line arrows are used to show power flows in FIG. 1 and solid line arrows are used to show signal flows. Power unit 14 includes a rechargeable battery 16 housed within a kinetic energy harvester (“KE harvester”) assembly 17. As described in more detail below, KE harvester 17 includes multiple piezoelectric elements that generate voltages in response to movement of mobile terminal 1. Electrical energy (arrow 20) output from these piezoelectric elements is received by a power controller 18. Power controller 18 includes electrical circuits that apply the energy output from assembly 17 as it is needed. When the electrical load of components in mobile terminal 1 is higher, controller 18 uses energy from harvesting assembly 17 to help satisfy that load. When the electrical load of mobile terminal 1 is lower, controller 18 applies the energy from harvesting assembly 17 to battery 16 so as to recharge battery 16. Controller 18 can also receive power from a conventional AC adapter for charging battery 16.

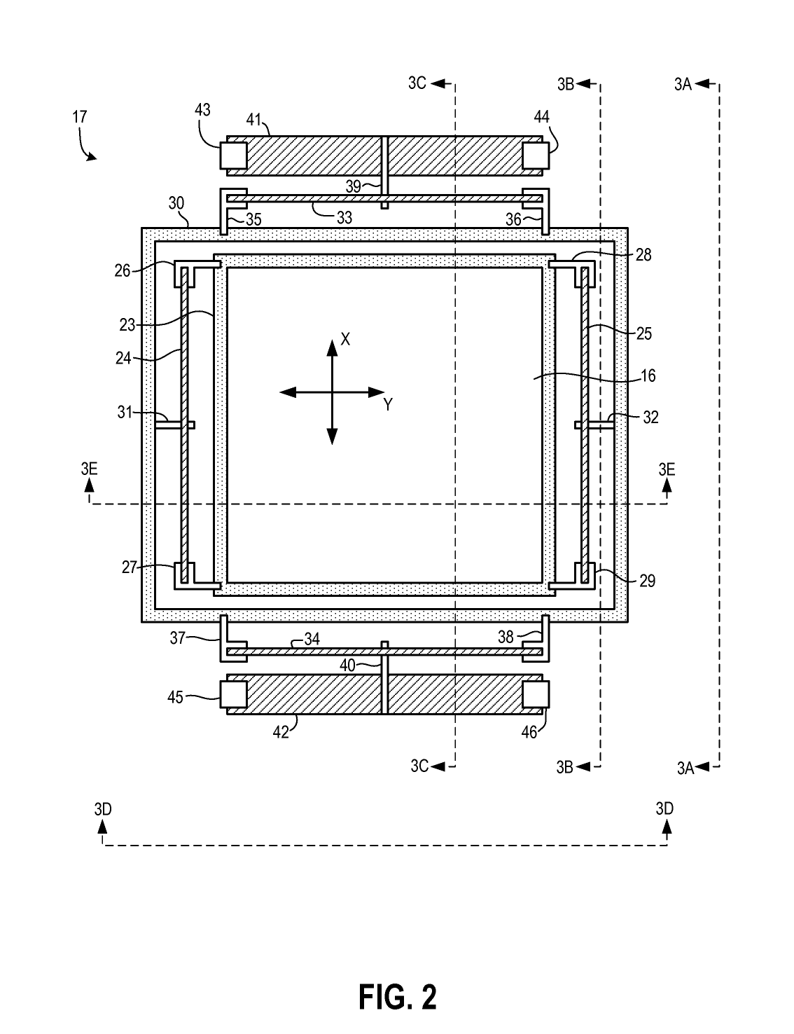

FIG. 2 is a partially schematic top view of KE harvester 17 and battery 16. Stippling and cross-hatching are used in FIG. 2 and subsequent figures merely to assist in distinguishing various depicted elements. Arbitrarily defined X and Y axes are also shown, with a Z axis being perpendicular to the plane of the drawing page. Battery 16 is retained within the frame of an inner battery holder 23. Battery 16 may be retained in inner holder 23 via a close frictional fit and/or by one or more electrical and/or mechanical connectors (not shown), or by some other mechanism. Piezoelectric strips 24 and 25 are attached on opposite sides of inner holder 23 with clips 26 and 27 (strip 24) and clips 28 and 29 (strip 25). Each clip 26, 27, 28 and 29 has a first end embedded within inner holder 23 and a second end clamped onto an end of a piezoelectric strip. Inner holder 23 is nested within an outer holder 30. Inner holder 23 and attached strips 24 and 25 are supported along the Y axis by clips 31 and 32. One end of clip 31 is embedded in the left inner wall of outer holder 30 and the other end is clamped onto the middle of piezoelectric strip 24. Similarly, one end of clip 32 is embedded in the right inner wall of outer holder 30 and the other end is clamped onto the middle of piezoelectric strip 25.

Piezoelectric strip 33 is attached to the top outer surface of outer holder 30 with clips 35 and 36, which clips each have a first end embedded into outer housing 30 and a second end clamped onto an end of piezoelectric strip 33. Piezoelectric strip 34 is attached to the bottom outer surface of outer holder 30 with clips 37 and 38, with each of clips 37 and 38 having a first end embedded into outer housing 30 and a second end clamped onto an end of piezoelectric strip 34. Outer holder 30, inner holder 23, and attached piezoelectric strips 24, 25, 33 and 34 are supported along the X axis by clips 39 and 40. Clip 39 has a first end clamped onto the middle of piezoelectric strip 33 and a second end clamped onto the middle of piezoelectric strip 41. Clip 40 has a first end clamped onto the middle of piezoelectric strip 34 and a second end clamped onto the middle of piezoelectric strip 42.

Outer holder 30, inner holder 23, and attached piezoelectric strips 24, 25, 33, 34, 41 and 42 are supported in a Z direction by clips attached to sides of strips 41 and 42. Each of clips 43 and 44 has a first end clamped onto an end of piezoelectric strip 41. Each of clips 43 and 44 has a second end (not shown in FIG. 2) that is embedded into a structure that is fixed relative to the components of KE harvester 17 shown in FIG. 2. In the embodiment of FIGS. 1-6, that structure is the chassis of mobile terminal 1. In other embodiments, that structure may be an outer casing for KE harvester 17, which outer casing is in turn attached to the chassis of mobile terminal 1. In a similar manner, each of clips 45 and 46 has a first end clamped onto an end of piezoelectric strip 42 and a second end embedded into the mobile terminal 1 chassis.

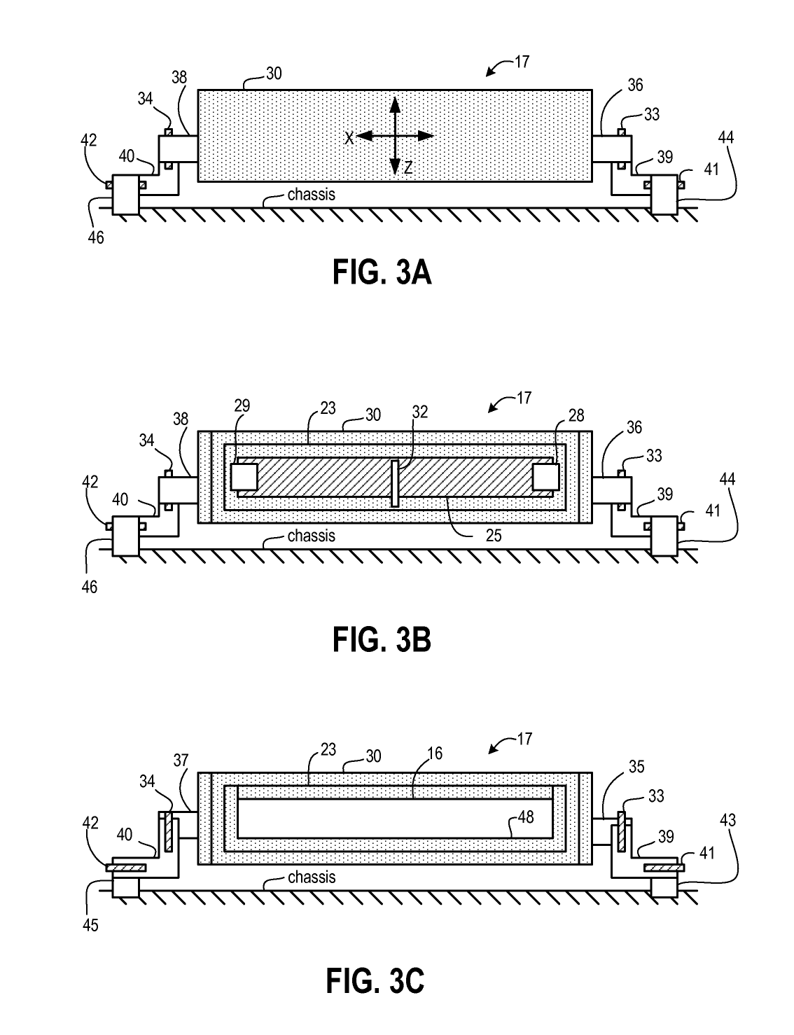

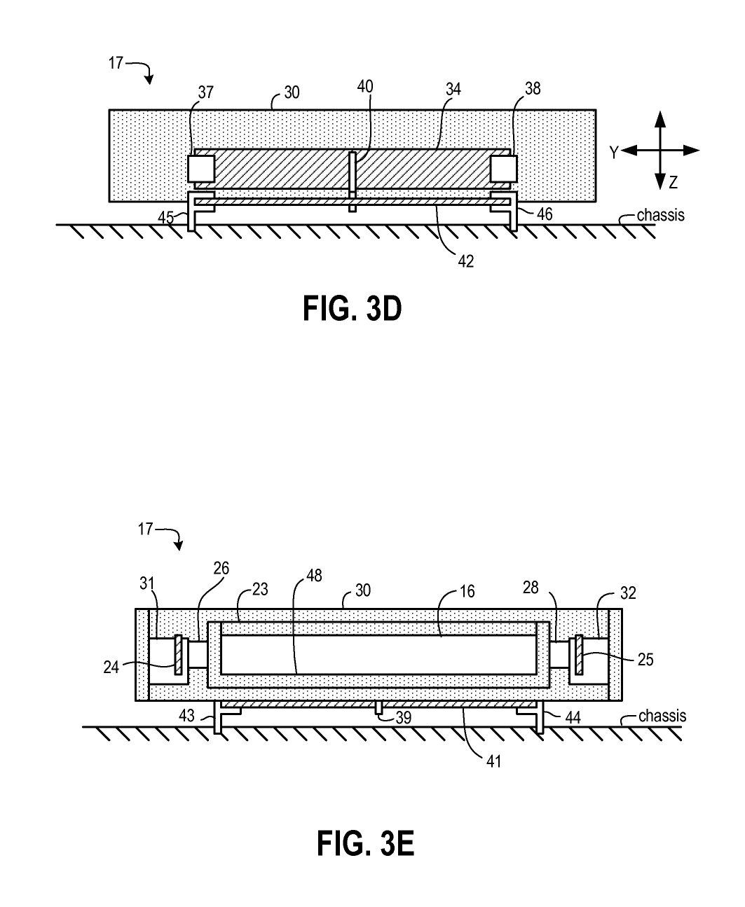

FIGS. 3A-3E are side views further illustrating the arrangement of components in KE harvester 17. FIG. 3A, a right side view taken from the location shown by arrows 3A-3A in FIG. 2 and rotated 90° clockwise, shows ends of Z-axis support clips 44 and 46 embedded into the chassis of mobile terminal 1. The X and Z axes are also shown. As explained in more detail below, forces associated with movement of mobile terminal 1 along the X axis generate voltages in piezoelectric strips 33 and 34. Forces associated with movement along the Z axis generate voltages in piezoelectric strips 41 and 42.

FIG. 3B is a cross-sectional view taken from the location shown by arrows 3B-3B in FIG. 2 and also rotated 90° clockwise. Piezoelectric strip 25 and clips 28, 29 and 32 are visible in FIG. 3B. As also discussed below, forces resulting from movement of mobile terminal 1 along the Y axis (which extends out of the page of FIG. 3B) cause piezoelectric strips 24 and 25 to generate voltages.

FIG. 3C is a cross-sectional view taken from the location shown by arrows 3C-3C in FIG. 2 and is also rotated 90° clockwise. As seen in FIG. 3C, inner holder 23 has a bottom surface 48 on which battery 16 rests. The lower side of outer holder 30 is open in the embodiment of FIGS. 2-6. FIG. 3D is a bottom side view taken from the location shown by arrows 3D-3D in FIG. 2. FIG. 3E is a cross-sectional view taken from the location shown by arrows 3E-3E in FIG. 2.

Each of piezoelectric strips 24, 25, 33, 34, 41 and 42 is in at least some embodiments a multi-layered piezoelectric strip having a metallic substrate with multiple layers of piezo ceramic and insulation. Such piezoelectric devices are commercially available from a variety of sources such as Hokuriku Electric Industry Co., Ltd. (of Tokyo, Japan) and Murata Manufacturing Company, Ltd. (of Kyoto, Japan). Each of these piezoelectric strips has two electrical contacts. A wire or other electrical path connects each of those contacts to a power collection circuit within controller 18. To avoid confusing the drawings with unnecessary detail, electrical attachments to the piezoelectric strips and corresponding electrical leads are not shown in FIGS. 2-6. In response a force exerted on any of piezoelectric strips 24, 25, 33, 34, 41 and 42, a voltage is induced across the electrical contacts on that strip. The attached wires or other leads apply these voltages across one or more capacitors within the power collection circuit of controller 18, which capacitors store the charge energy associated with these applied voltages. Controller 18 then repeatedly discharges those capacitors so as to output electrical power.

Other types of piezoelectric devices can be used. In other embodiments, for example, single layer or dual layer bimorph types of piezoelectric devices can be used. Moreover, the piezoelectric strips need not have the shapes shown in the drawings. In at least some embodiments, a piezo-electric strip (or other device) is “tuned” so as to have a spring constant that causes the device to resonate at one or more desired frequencies. The specifics of such tuning, which can be achieved by adjusting the physical dimensions (length, width, thickness) and construction (e.g., number of layers, type of materials used) of the strip, will depend on location of a strip within a mobile terminal or other device and the mass of various components in the device. Similarly, the capacitance of a piezo-electric strip can be tuned (by adjusting physical dimensions and construction) based on the electrical requirements of a mobile terminal or other device. Tuning of a piezo-electric strip to have a desired spring constant and capacitance is within the ability of a person of ordinary skill once such a person is provided with the information contained herein.

Various circuit arrangements for accumulating charge from piezoelectric elements and converting that accumulated charge to output power are known in the art, and thus further details of the circuitry within controller 18 are not contained herein. Selection and/or design of an appropriate circuit is within the routine ability of a person of ordinary skill in the art once such a person has been provided with the information contained herein.

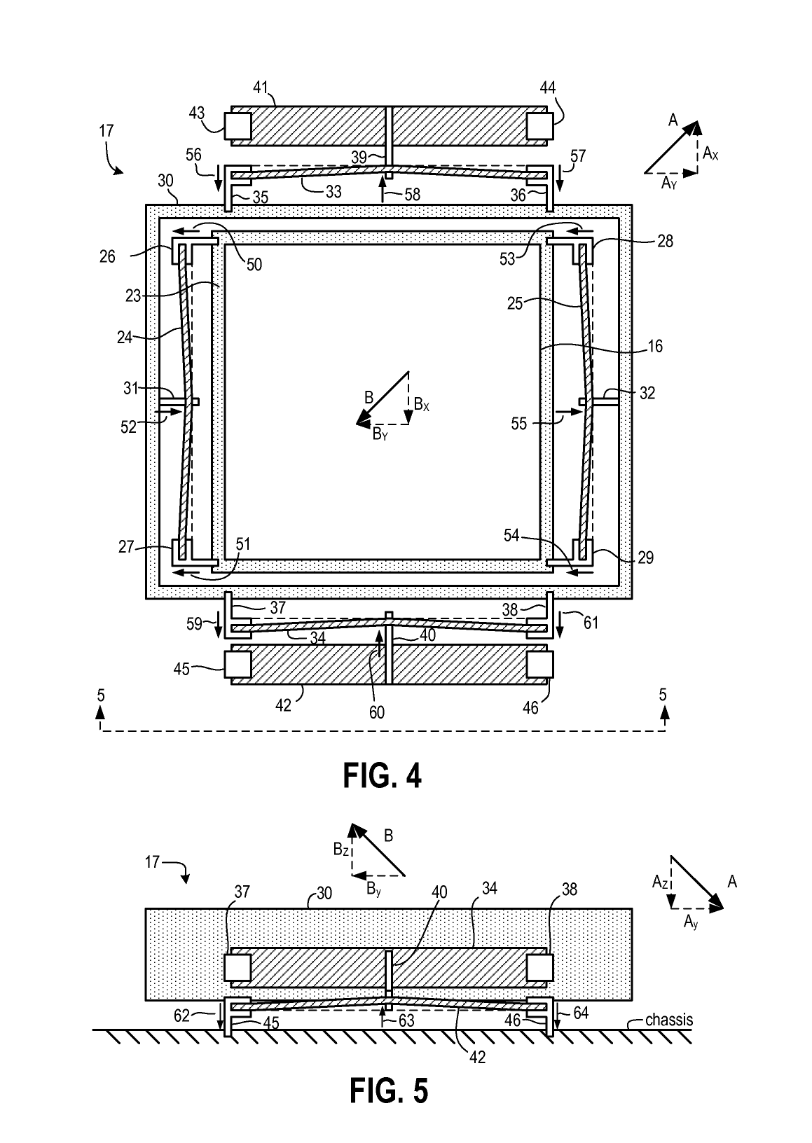

FIGS. 4 and 5 illustrate operation of KE harvester 17. FIG. 4 is another top view of KE harvester 17, and FIG. 5 is a side view taken from the location shown by arrows 5-5 in FIG. 4. Arrow “A” represents an acceleration of mobile terminal 1 in a direction having components A_{X}, A_{Y} and A_{Z} along the X, Y and Z axes, respectively. These axes are not shown in FIG. 4, but have the same orientation as is shown in FIGS. 2, 3A and 3D. This translational acceleration A of mobile terminal 1 is the result of a typical user movement of mobile terminal 1. Such a movement could be associated with walking while mobile terminal 1 is in the user's pocket or purse, moving mobile terminal 1 to the user's ear, etc. In response to acceleration A of mobile terminal 1, the mass of battery 16 and other elements of KE harvester 17 induce a force B, relative to the chassis of mobile terminal 1, in the direction shown by arrow B. Force B includes components B_{X}, B_{Y} and B_{Z} along the X, Y and Z axes previously defined.

In response to the Y-axis component of force B, forces 50 and 51 are applied to piezoelectric strip 24. A reactive force 52 is similarly imposed on piezoelectric strip 24 by clip 31. In response to these forces on piezoelectric strip 24, strip 24 outputs a voltage across the leads (not shown) attached to its electrical contacts. The Y component of force B also applies forces 53, 54 and 55 to piezoelectric strip 25, thereby causing strip 25 to output a voltage across the leads (not shown) attached to its electrical contacts. The X component of force B applies forces 56, 57 and 58 to piezoelectric strip 33 and forces 59, 60 and 61 to piezoelectric strip 34, resulting in voltages generated by piezoelectric strips 33 and 34. The Z component of force B applies forces 62, 63 and 64 to piezoelectric strip 42 and similar forces (not shown in FIG. 4 or in FIG. 5) to piezoelectric strip 41, resulting in voltages generated by piezoelectric strips 41 and 42.

As it is used or carried throughout the course of normal activity, mobile terminal 1 is accelerated in many other directions, each of which imposes forces in various directions on some or all of piezoelectric strips 24, 25, 33, 34, 41 and 42. Over time, the combined effect of these forces on the piezoelectric strips will generate significant power. For example, and assuming that battery 16 has mass of 50 mg, an estimated 100 mW could be produced from random accelerations of mobile terminal 1 while the terminal is carried by a walking user.

As also shown in FIGS. 4 and 5 with broken lines, the forces applied to piezoelectric strips 24, 25, 33, 34, 41 and 42 cause small deflections of those strips. However, the deflections shown in FIGS. 4 and 5 are exaggerated for purposes of illustration. Indeed, one advantage of piezoelectric elements over other systems for converting kinetic energy to electrical power (e.g., magnetic induction) is that very little relative motion is necessary. It is estimated that the actual magnitude of deflections in piezoelectric elements 24, 25, 33, 34, 41 and 42 will be such that movement of battery 16 relative to the chassis will be largely imperceptible to a user of mobile terminal 1.

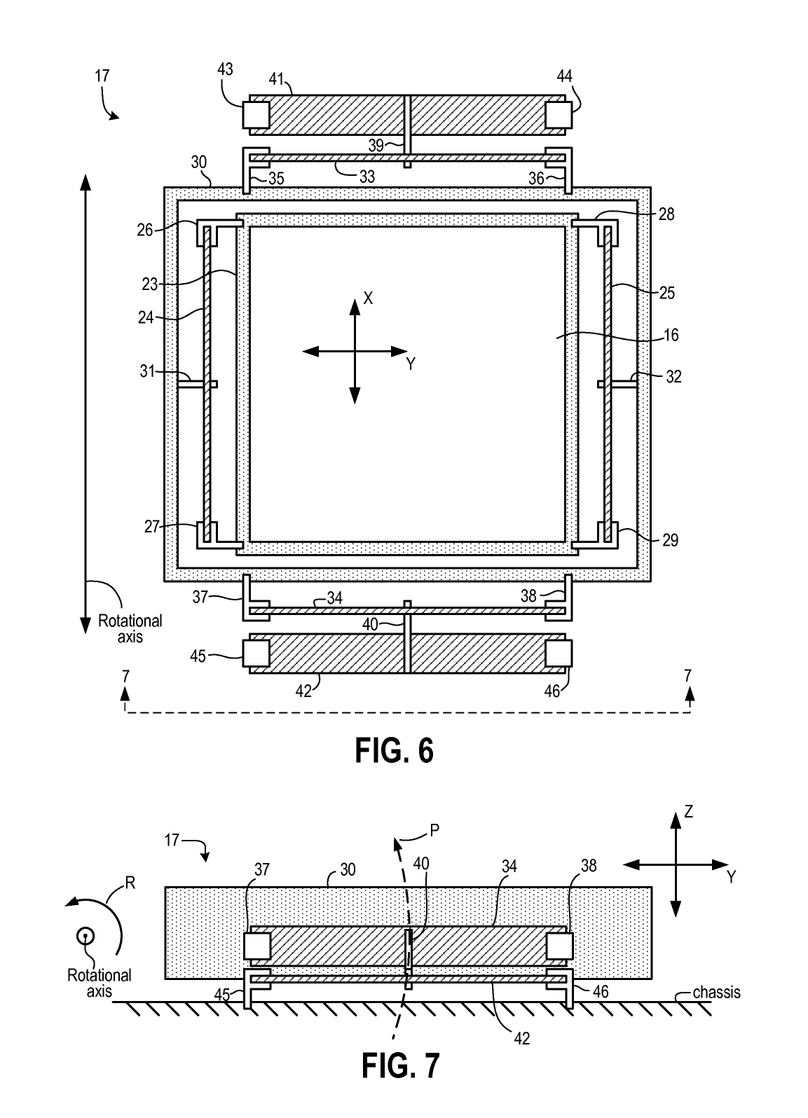

Although the operation of KE harvester 17 has been described using translational accelerations and forces along the arbitrarily defined axes X, Y and Z, piezoelectric strips of KE harvester 17 will also output voltages in response to forces associated with rotational acceleration of mobile terminal 1 about one or more arbitrarily-defined rotational axes. For example, FIGS. 6 and 7 show the effect on KE harvester 17 of a rotational acceleration R about a rotational axis that is parallel to the previously-defined X axis and offset from KE harvester 17. Rotational acceleration R moves KE harvester 17 about a circular path P (FIG. 7). This motion P has components that include an upward acceleration parallel to the Z axis. As a result of that Z-axis acceleration, the mass of battery 16 imposes a downward force (also parallel to the Z axis) that is transferred to piezoelectric strips 41 and 42 and cause strips 41 and 42 to generate voltages.

Although voltages from piezoelectric elements 41 and 42 resulting from rotational acceleration of mobile terminal 1 may in some cases not be as great as voltages resulting from pure translational acceleration, there is still a contribution to the electrical energy output from KE harvester 17. In some embodiments, piezoelectric elements are repositioned and/or additional piezoelectric elements are added so as to increase energy generated from rotational movements of a device. For example, in response to rotation of the mobile terminal about an axis parallel to the X axis and passing through KE harvester 17, torque would be applied to piezoelectric strips 41 and 42 by clips 39 and 40, respectively. These torques would tend to bend strips 41 and 42 into an “S” curve. However, some piezoelectric strips do not output energy when bent in such a fashion. To address this, piezoelectric strips 41 and 42 could each be replaced with two separate piezoelectric strips. One end of each of those strips would be attached to the mobile terminal chassis with one of clips 43, 44, 45 or 46. The other end of each of the two strips replacing strip 41 would be coupled to piezoelectric strip 33, and the other end of each of the two strips replacing strip 42 would be coupled to piezoelectric strip 34. Each of the four replacement strips would then be separately coupled to the power controller.

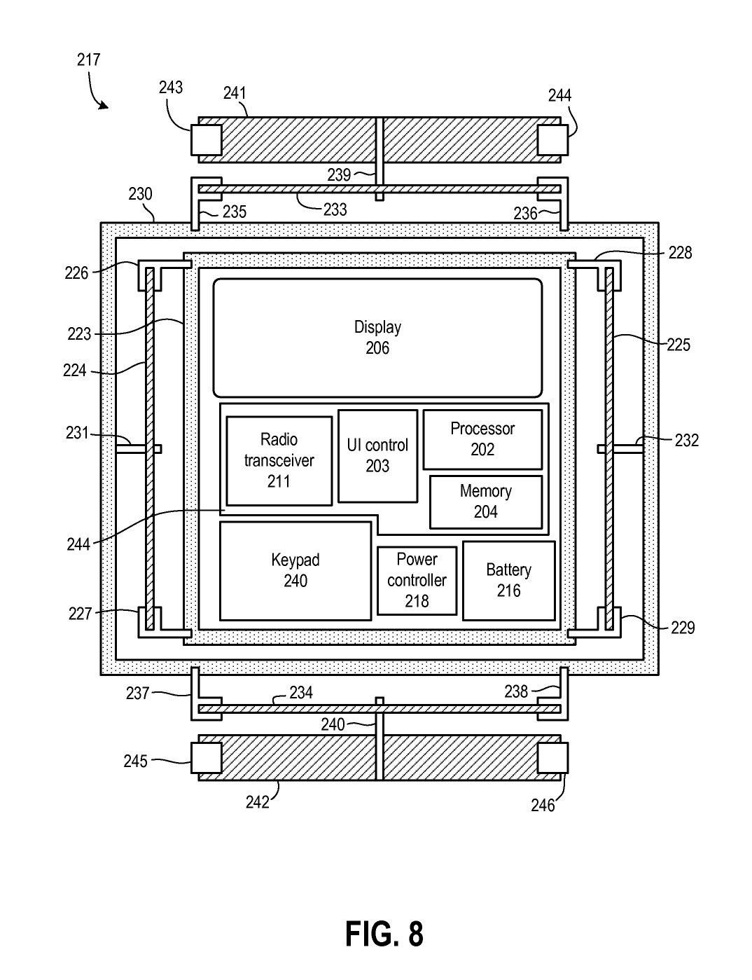

Although a battery is often one of the heaviest components of a wireless device such as a mobile terminal, other components also have significant mass. If the mass from some of those elements is added to the mass of a battery in a KE harvester, additional electrical energy can be generated. FIG. 8 is a partially schematic top view of a KE harvester 217, according to another embodiment, in which the mass of additional device components is so used. KE harvester 217 is similar to, and functions in the same way as, KE harvester 17 of FIG. 2. In the embodiment of FIG. 8, however, additional components from a mobile terminal have been located within an inner holder 223. In addition to a battery 216, a display 206, power controller 218, keypad 240 and circuit board 244 (which circuit board includes a processor 202, memory 204, transceiver 211 and user interface control 203) are all attached to inner holder 223. Other elements of the embodiment of FIG. 8 are similar to the elements in the embodiment of FIGS. 1-7 and have been given similar reference numbers, but with 200 added. For example, piezoelectric elements 224, 225, 233, 234, 241 and 242 of FIG. 8 are similar to elements 24, 25, 33, 34, 41 and 42 of FIG. 2, except that they may be sized to optimize power harvestable from increased mass.

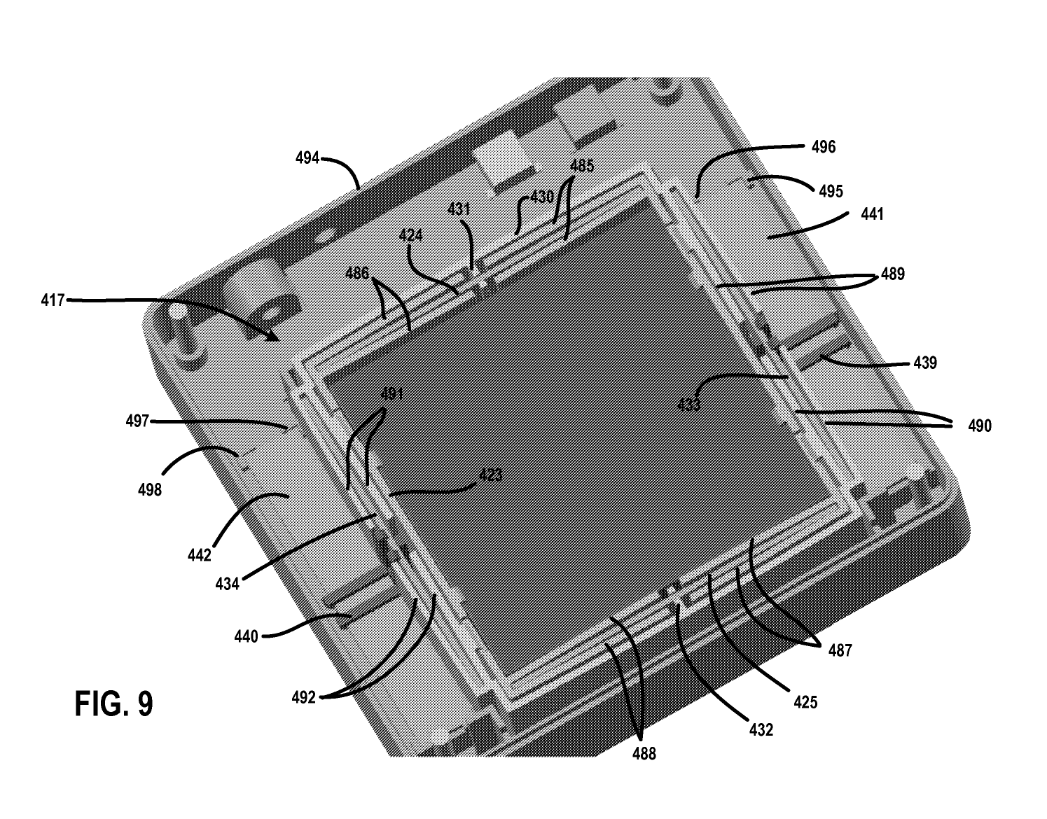

FIG. 9 is a perspective view of a KE harvester 417 according to another embodiment. Elements of the embodiment of FIG. 9 are similar to the elements in the embodiment of FIGS. 1-7 and have been given similar reference numbers, but with 400 added. KE harvester 417 is generally similar to KE harvesters 17 and 217 of FIGS. 1-7. In KE harvester 417, clips 26 and 27 of FIG. 2 have been replaced with brackets 485 and 486 that are integrally molded into the side of inner holder 423. Clips 28 and 29 of FIG. 2 have similarly been replaced with brackets 487 and 488 that are integrally molded into the side of inner holder 423, and clips 35, 36, 37 and 38 have been replaced with brackets 489, 490, 491 and 492 that are integrally molded into outer holder 430. Clips 43 through 46 from the embodiment of FIG. 2 are eliminated in the embodiment of FIG. 8. Instead, Z-axis support for KE harvester 417 (and other components held by inner holder 423) is provided by brackets located, at each corner of piezoelectric strips 441 and 442, that are integrally formed in chassis 494 of the mobile terminal. Four of those brackets (495, 496, 497 and 498) are visible in FIG. 9.

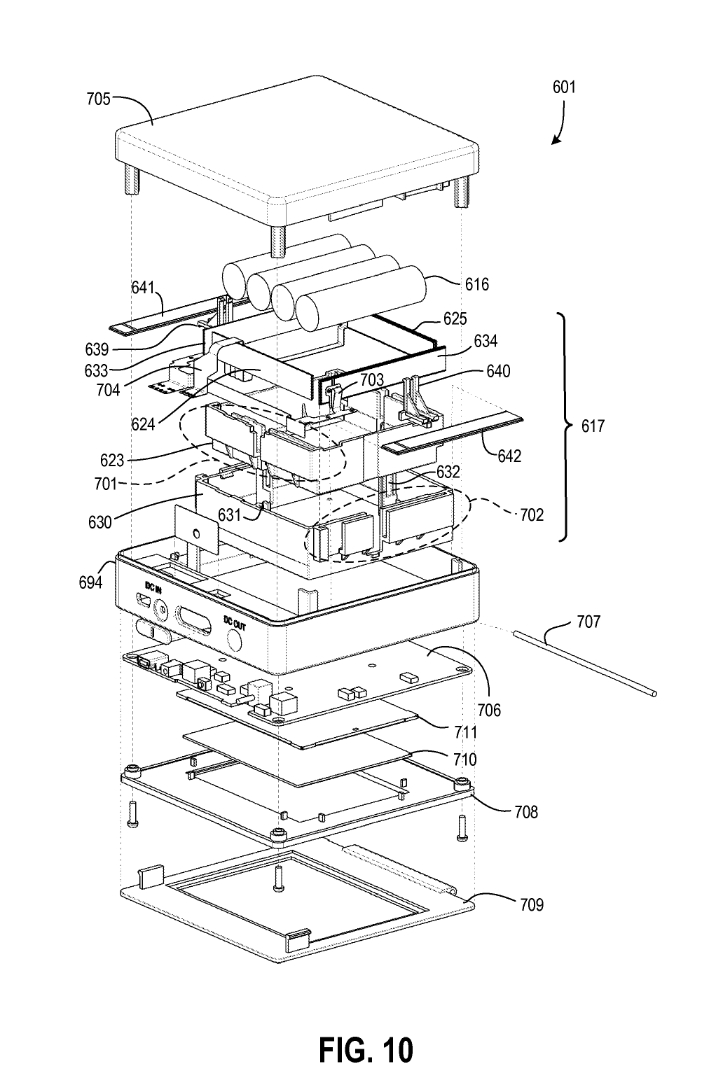

FIG. 10 is an exploded perspective view of a KE harvester 617 in a mobile terminal 601 according to another embodiment. Elements of the embodiment of FIG. 10 that are similar to elements in the embodiment of FIGS. 1-7 and have been given similar reference numbers, but with 600 added. Similar to the embodiment of FIG. 9, clips 26 and 27 of FIG. 2 have been replaced with a bracket 701 that is formed as an integral part of inner holder 623. Clips 28 and 29 are similarly replaced with a bracket on the opposite side of inner holder 623. Clips 37 and 38 of FIG. 2 have been replaced with a bracket 702 that is formed as an integral part of outer holder 630. Clips 35 and 36 are similarly replaced with a bracket on the opposite side of outer holder 630. FIG. 10 further shows electrical leads 703 and 704 attached to piezoelectric strips 634 and 624. Clips coupling piezoelectric strips 641 and 642 to chassis 694 are not visible in FIG. 10. Other features shown in FIG. 10 include lower chassis cover 705 (FIG. 10 shows mobile terminal 601 upside down), circuit board 706, upper chassis cover 708, device cover 709, cover hinge pin 707, transparent display cover 710, and touch-sensitive input device 711.

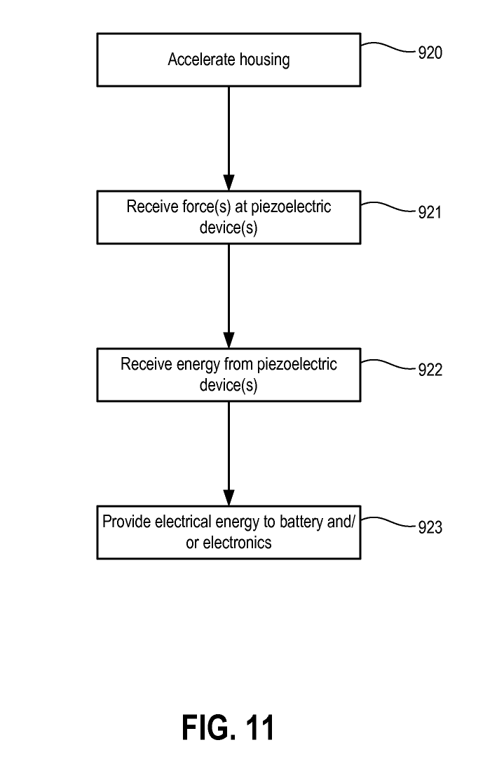

FIG. 11 is a flow chart showing generation of energy using a KE harvester according to one or more of the above-described embodiments. First, the mobile terminal is accelerated (block 920). In response to this acceleration, forces are imposed on one or more piezoelectric devices (block 921). In response to those forces, the piezoelectric devices output electrical energy, which energy is received at a power controller (block 922). The power controller then makes this energy available to recharge a battery and/or to electronic components of the mobile terminal (block 923). Although FIG. 11 shows a serial flow of events, it is to be appreciated that the events of blocks 921, 922 and 923 occur substantially instantaneously upon acceleration of the mobile terminal.

Although various embodiments have been described in the context of a KE harvester used in a mobile terminal, other embodiments include KE harvesters implemented in a wide variety of other battery powered devices. Examples of such other devices include (but are not limited to) personal digital assistants, laptop computers, portable digital music players, broadcast receivers, GPS receivers, etc.

Although examples of carrying out the invention have been described, those skilled in the art will appreciate that there are numerous other variations, combinations and permutations of the above described devices and techniques that fall within the spirit and scope of the invention as set forth in the appended claims. The above description and drawings are illustrative only. The invention is not limited to the illustrated embodiments, and all embodiments of the invention need not necessarily achieve all of the advantages or purposes, or possess all characteristics, identified herein. As used herein (including the claims), a “controller” may include any of one or more of the following: discrete analog circuit elements, a field programmable gate array, a microprocessor, and an integrated circuit. As also used herein (including the claims), “coupled” includes two components that are attached (either fixedly or movably) by one or more intermediate components.

1. An apparatus comprising:
a device housing;
a holder configured to retain a battery;
a first piezoelectric element coupling the holder to the device housing and configured to receive, as a result of acceleration of the device housing and along a first axis, a first portion of a force of imposed by a mass of a battery retained in the holder;
a second piezoelectric element coupling the holder to the device housing and configured to receive, as a result of the device housing acceleration and along a second axis that is non-parallel to the first axis, a second portion of the force imposed by the mass of the battery retained in the holder; and
a controller configured to receive electrical energy output by the first and second piezoelectric elements in response to the first and second force portions and to make the received electrical energy available for at least one of
satisfying at least part of an electrical load satisfiable by the battery retained in the holder, and
recharging the battery retained in the holder.

2. The apparatus of claim 1, further comprising a frame, and wherein
the first piezoelectric element couples the holder to the frame, and
the second piezoelectric element couples the frame to the device housing.

3. The apparatus of claim 1, further comprising a third piezoelectric element coupling the holder to the device housing and configured to receive, as a result of the device housing acceleration and along a third axis that is orthogonal to the first and second axes, a third portion of the force of imposed by the mass of the battery retained in the holder, and wherein the controller is configured to receive electrical energy output by the first, second and third piezoelectric elements in response to the first, second and third force portions.

4. The apparatus of claim 3, wherein the third piezoelectric element couples the second piezoelectric element to the device housing.

5. The apparatus of claim 1, wherein
the first and second piezoelectric elements also couple the controller to the device housing, and
the first and second force portions include portions of a force imposed by a mass of the controller in response to the acceleration.

6. The apparatus of claim 1, further including at least one additional device component selected from the group that includes a display, a transceiver, a user interface control, a memory, a processor, a power controller and a keypad, and wherein
the first and second piezoelectric elements also couple the at least one additional component to the device housing, and
the first and second force portions include portions of a force imposed by a mass of the at least one additional component in response to the acceleration.

7. The apparatus of claim 1, further comprising a third piezoelectric element, a transceiver, a keypad and a display, and wherein
the first and second piezoelectric elements also couple the controller, the transceiver, the keypad and the display to the device housing,
the first and second force portions include portions of forces imposed by masses of the controller, the transceiver, the keypad and the display,
the third piezoelectric element couples the holder, the controller, the transceiver, the keypad and the display to the device housing,
the third piezoelectric element is configured to receive, as a result of the device housing acceleration and along a third axis that is orthogonal to the first and second axes, at least a third portion of the forces imposed by the masses of the battery retained in the holder, the controller, the transceiver, the keypad and the display, and
the controller is configured to receive electrical energy output by the first, second and third piezoelectric elements in response to the first, second and third force portions.

8. A apparatus comprising:
a device housing;
first and second holding frames;
at least one electrical component held within the first holding frame;
a first piezoelectric element coupling the first holding frame to the second holding frame;
a second piezoelectric element coupling the second holding frame to the device housing; and
a third piezoelectric element coupling the second holding frame to the device housing.

9. The apparatus of claim 8, further comprising a controller configured to receive electrical energy output by the first, second and third piezoelectric elements in response to forces imposed on those piezoelectric elements in response to an acceleration of the device housing and to make the received electrical energy available for recharging a battery.

10. The apparatus of claim 9, wherein the first piezoelectric element is attached to the first and second holding frames, the second piezoelectric element is attached to the second holding frame and the third piezoelectric element, and the third piezoelectric element is attached to the second piezoelectric element and the device housing.

11. The apparatus of claim 9, wherein the at least one electrical component includes a battery.

12. The apparatus of claim 9, wherein the at least one component includes a transceiver.

13. An apparatus comprising:
means for retaining a battery;
a plurality of piezoelectric components;
means for transferring to the piezoelectric components, along a plurality of nonparallel axes, forces imposed by a mass of a battery held within the retaining means in response to an acceleration of the apparatus; and
a controller configured to receive electrical energy output by the piezoelectric elements in response to the imposed forces and to make the received electrical energy available for at least one of
satisfying at least part of an electrical load satisfiable by the battery held with the retaining means, and
recharging the battery held with the retaining means.

14. The apparatus of claim 13, further comprising a display, a transceiver and a keypad, and wherein the forces imposed include forces imposed by the masses of the controller, the display, the transceiver and the keypad.

15. The apparatus of claim 13, wherein the plurality of nonparallel axes comprises three mutually orthogonal axes.

16. A apparatus comprising:
a chassis;
a first holding frame configured to retain a battery;
a display, a keypad and a transceiver held within the first holding frame;
a second holding frame;
first and second piezoelectric strips, each of the first and second piezoelectric strips having two ends attached to one of the first and second holding frames and a middle attached to the other of the first and second holding frames;
third, fourth, fifth and sixth piezoelectric strips, each of the third and fourth piezoelectric strips having ends attached to the second holding frame, each of the fifth and sixth piezoelectric strips having ends attached to the chassis, the third piezoelectric strip having a middle attached to a middle of the fifth piezoelectric strip, and the fourth piezoelectric strip having a middle attached to a middle of the sixth piezoelectric strip; and
a controller configured to receive electrical energy output by the piezoelectric strips in response to the forces imposed by masses of a battery retained in the first holding frame, the display, the keypad and the transceiver in response to acceleration of the chassis, and to make the received electrical energy available for at least one of
satisfying at least part of an electrical load satisfiable by the battery retained in the first holding frame, and
recharging the battery retained in the first holding frame.

17. A method comprising:
accelerating a device housing;
receiving, along a first axis and at a first piezoelectric element, a first portion of a force induced by a mass of a battery in response to accelerating the device housing;
receiving, at a second piezoelectric element and along a second axis that is nonparallel to the first axis, a second portion of the force induced by the mass of a battery in response to accelerating the device housing; and
receiving electrical energy output by the first and second piezoelectric elements in response to the first and second force portions,
making the received electrical energy available for at least one of
satisfying at least part of an electrical load satisfiable by the battery, and
recharging the battery.

18. The method of claim 17, further comprising receiving, at a third piezoelectric element and along a third axis that is orthogonal to the first and second axes, a third portion of the force induced by the mass of the battery, and wherein receiving electrical energy output by the first and second piezoelectric elements includes receiving electrical energy output by the third piezoelectric element in response to the third force portion.

19. The method of claim 17, wherein accelerating the device housing includes accelerating the device housing about at least one rotational axis.
